(19) United States
(12) Patent Application Publication
(10) Pub. No.: US 2024/0324681 A1
(43) Pub. Date: Oct. 3, 2024

(54) AEROSOL GENERATING APPARATUS, HEATER FOR AEROSOL GENERATING APPARATUS, AND PREPARATION METHOD

(71) Applicant: SHENZHEN FIRST UNION TECHNOLOGY CO., LTD., Shenzhen, Guangdong Province (CN)

(72) Inventors: Shuyuan ZHANG, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/293,883

(22) PCT Filed: Aug. 3, 2022
(86) PCT No.: PCT/CN2022/110085

§ 371 Date: Jan. 31, 2024

(30) Foreign Application Priority Data
Aug. 4, 2021 (CN) 202110890586.3
Jun. 30, 2022 (CN) 202210779126.8

(51) Int. Cl. A24F 40/465

(52) U.S. Cl. CPC A24F 40/465

(57) ABSTRACT

An aerosol generation device, a heater for an aerosol generation device, and a preparation method are presented. The aerosol generation device includes: a cavity, configured to receive an aerosol-forming product A; and a heater, at least partially extending in the cavity, to heat the aerosol-forming product A received in the cavity, where the heater includes: an induction coil, configured to generate a variable magnetic field; and a susceptor, configured to be penetrated by the variable magnetic field to generate heat, where the susceptor is formed by molding a moldable sensing material on the induction coil, and wraps the induction coil. In the aerosol generation device, the susceptor is formed and is integrated into one body on the induction coil by molding, which is advantageous for miniaturization of the device

### CROSS-REFERENCE TO RELATED APPLICATIONS

This application claims priority to Chinese Patent Application No. 202110890586.3, filed with the China National Intellectual Property Administration on Aug. 4, 2021 and entitled “AEROSOL GENERATION DEVICE, HEATER FOR AN AEROSOL GENERATION DEVICE, AND PREPARATION METHOD”, which is incorporated herein by reference in its entirety.

This application claims priority to Chinese Patent Application No. 202210779126.8, filed with the China National Intellectual Property Administration on Jun. 30, 2022 and entitled “AEROSOL GENERATION DEVICE, HEATER FOR AN AEROSOL GENERATION DEVICE, AND PREPARATION METHOD”, which is incorporated herein by reference in its entirety.

### TECHNICAL FIELD

Embodiments of this application relate to field of aerosol generation technologies, and in particular, to an aerosol generation device, a heater for an aerosol generation device, and a preparation method.

### BACKGROUND

Tobacco products (such as cigarettes and cigars) burn tobacco during use to produce tobacco smoke. Attempts are made to replace these tobacco-burning products by manufacturing products that release compounds without combustion.

An example of products of this type is a heating device. As shown in FIG. 1, a magnetic field is generated by using an induction coil 1, and heat generation is induced by using a sensor 2 arranged in the coil, to heat a tobacco product. In a heating device of this type, an induction coil occupies a large space, which is disadvantageous for miniaturization of the heating device.

### SUMMARY

Embodiments of this application provides an aerosol generation device, a heater for an aerosol generation device, and a preparation method, which can reduce volumes of an aerosol generation device and a heater.

According to a first aspect, an embodiment of this application provides an aerosol generation device, configured to heat an aerosol-forming product to generate an aerosol, and including:
a cavity, configured to receive the aerosol-forming product; and
a heater, at least partially extending in the cavity, to heat the aerosol-forming product received in the cavity, where the heater includes:
an induction coil, configured to generate a variable magnetic field; and
a susceptor, configured to be penetrated by the variable magnetic field to generate heat, where the susceptor is formed by molding a moldable sensing material on the induction coil, and wraps the induction coil.

In a more preferred implementation, the induction coil is buried or embedded in the susceptor.

In a more preferred implementation, the induction coil is not exposed outside the susceptor.

In a more preferred implementation, the induction coil is constructed in a form of a spiral coil extending in an axial direction of the heater; and
a section of a conducting wire material of the induction coil is constructed to be in a flat shape.

In a more preferred implementation, the section of the conducting wire material of the induction coil is constructed to have an extension size in an axial direction of the induction coil greater than an extension size in a radial direction.

In a more preferred implementation, the heater further includes:
a conductive pin, connected to the induction coil, to supply power to the induction coil, where the conductive pin at least partially penetrates from the inside of the susceptor to the outside of the susceptor.

In a more preferred implementation, further includes that the conductive pin includes a first conductive pin and a second conductive pin that are of different materials, to form, between the first conductive pin and the second conductive pin, a thermocouple configured to sense a temperature of the heater.

In a more preferred implementation, the variable magnetic field is basically limited in the susceptor.

In a more preferred implementation, the variable magnetic field basically has no magnetic leakage outside the susceptor.

In a more preferred implementation, the induction coil has 6 to 20 windings or turns.

In a more preferred implementation, the induction coil has an extension length of 8 mm to 12 mm, an outer diameter of 1 mm to 3 mm, and an inner diameter of 0.5 mm to 1.5 mm.

According to a second aspect, an embodiment of this application further provides an aerosol generation device, configured to heat an aerosol-forming product to generate an aerosol, and including:
a cavity, configured to receive the aerosol-forming product; and
a heater, at least partially extending in the cavity, to heat the aerosol-forming product received in the cavity, where the heater includes:
an induction coil, configured to generate a variable magnetic field;
a base body, formed by molding a moldable material on the induction coil, and wrapping the induction coil; and
a sensing coating, formed on the base body, and configured to be penetrated by the variable magnetic field to generate heat.

In a more preferred implementation, the base body includes a ceramic material, for example, an insulating material such as a metal oxide (such as MgO, Al₂O₃, or B₂O₃) or a metal nitride (such as Si₃N₄, B₃N₄, or Al₃N₄), or another highly heat-conductive composite ceramic material.

In a more preferred implementation, the base body is an insulating material. The base body and the induction coil and/or the sensing coating are insulated from each other, so that the base body provides insulation between the induction coil and the sensing coating.

According to a third aspect, an embodiment of this application further provides a heater for an aerosol generation device, including:
an induction coil, configured to generate a variable magnetic field; and
a susceptor, configured to be penetrated by the variable magnetic field to generate heat, where the susceptor is formed by molding a moldable sensing material on the induction coil, and wraps the induction coil.

According to a fourth aspect, an embodiment of this application further provides a method for preparing a heater for an aerosol generation device, including the following steps:
providing an induction coil; and
forming a susceptor by molding a moldable sensing material on the induction coil and wrapping the induction coil.

In the foregoing aerosol generation device, the susceptor is formed and is integrated into one body on the induction coil by molding, which is advantageous for miniaturization of the device.

According to a fifth aspect, an embodiment of this application further provides an aerosol generation device, configured to heat an aerosol-forming product to generate an aerosol, and including:
a cavity, configured to receive the aerosol-forming product; and
a heater, at least partially extending in the cavity, to heat the aerosol-forming product received in the cavity, where the heater includes a resistance heating coil and a heat conductor; the heat conductor is configured to receive heat of the resistance heating coil to generate heat, to heat the aerosol-forming product received in the cavity; and the heat conductor is formed by molding a moldable material on the resistance heating coil, and wraps the resistance heating coil.

In a more preferred implementation, the heat conductor is formed by solidification of a molten liquid precursor at least partially surrounding the resistance heating coil.

In a more preferred implementation, a section of a conducting wire material of the resistance heating coil is in a flat shape.

In a more preferred implementation, an extending size of the section of the conducting wire material of the resistance heating coil in an axial direction is greater than an extension size in a radial direction.

In a more preferred implementation, the resistance heating coil is 8 mm to 12 mm in extension length.

In a more preferred implementation, the resistance heating coil is constructed to be about 1 mm to 3 mm in outer diameter, and be 0.5 mm to 1.5 mm in inner diameter.

In a more preferred implementation, the extension size of the section of the conducting wire material of the resistance heating coil in the axial direction is between 0.5 mm and 4 mm. In a more preferred implementation, the extension size of the section of the conducting wire material of the resistance heating coil in the radial direction is between 0.05 mm and 0.5 mm.

The resistance heating coil has 6 to 20 windings or turns.

In a more preferred implementation, the heater further includes:
a conductive pin, connected to the resistance heating coil, to supply power to the resistance heating coil, where the conductive pin at least partially penetrates from the inside of the heat conductor to the outside of the heat conductor.

In a more preferred implementation, the conductive pin includes a first conductive pin and a second conductive pin that are of different materials, to form, between the first conductive pin and the second conductive pin, a thermocouple configured to sense a temperature of the heater.

In a more preferred implementation, the resistance heating coil is buried or embedded in the heat conductor.

In a more preferred implementation, the resistance heating coil is not exposed outside the heat conductor.

In a more preferred implementation, the heat conductor includes a non-metal inorganic material. The non-metal inorganic material includes a metal oxide, a metal nitride, or a ceramic.

In a more preferred implementation, the heat conductor includes or a metal or an alloy. In a more preferred implementation, the heat conductor includes Al.

According to a sixth aspect, an embodiment of this application further provides a heater for an aerosol generation device, including:
a resistance heating coil and a heat conductor, where the heat conductor is configured to receive heat of the resistance heating coil to generate heat; and the heat conductor is formed by molding a moldable material on the resistance heating coil, and wraps the resistance heating coil.

An embodiment of this application provides an aerosol generation device, configured to heat an aerosol-forming product to generate an aerosol, and including:
a cavity, configured to receive the aerosol-forming product;
a circuit; and
a heater, at least partially extending in the cavity, to heat the aerosol-forming product received in the cavity, where the heater includes:
a coil, including a conductive sensing material, and configured to generate heat when an alternating current is provided by the circuit; and
a heat conductor, configured to receive heat of the coil to generate heat, to heat the aerosol-forming product received in the cavity.

In a more preferred implementation, heating of the coil when the alternating current is provided by the circuit includes resistance Joule heating and electromagnetic induction heating.

In a more preferred implementation, the conductive sensing material includes a conductive ferromagnetic or ferrimagnetic material.

In a more preferred implementation, the heat conductor is formed by molding a moldable material on the coil, and wraps the coil.

In a more preferred implementation, the heater is in a pin or needle or rob or bar shape, and includes a free front end located in the cavity, and a rear end opposite to the free front end, where the free front end is constructed into a conical tip.

In a more preferred implementation, the heater further includes a base or flange; and the aerosol generation device holds the heater by using the base or flange.

In a more preferred implementation, the base or flange is positioned at the rear end.

In a more preferred implementation, a section of a conducting wire material of the coil is in a flat shape.

In a more preferred implementation, an extension size of the section of the conducting wire material of the coil in an axial direction is greater than an extension size in a radial direction.

In a more preferred implementation, the coil is 8 mm to 12 mm in extension length.

In a more preferred implementation, the coil is constructed to be about 1 mm to 3 mm in outer diameter, and be 0.5 mm to 1.5 mm in inner diameter.

In a more preferred implementation, the extension size of the section of the conducting wire material of the coil in the axial direction is between 0.5 mm and 4 mm. In a more preferred implementation, the extension size of the section of the conducting wire material of the coil in the radial direction is between 0.05 mm and 0.5 mm.

In a more preferred implementation, the coil is buried or embedded in the heat conductor.

In a more preferred implementation, the coil is not exposed outside the heat conductor.

An embodiment of this application provides an aerosol generation device, a heater for an aerosol generation device, and a preparation method, which can reduce volumes of an aerosol generation device and a heater.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of an existing heating device;

FIG. 2 is a schematic structural diagram of an aerosol generation device according to an embodiment;

FIG. 3 is a schematic cross-sectional view of a heater in FIG. 2 from a perspective;

FIG. 4 is a schematic structural diagram of a resistance heating coil or an induction coil according to an embodiment;

FIG. 5 is a schematic cross-sectional view of the resistance heating coil or the induction coil in FIG. 4 from a perspective;

FIG. 6 is a schematic structural diagram of a resistance heating coil or an induction coil according to another embodiment;

FIG. 7 is a schematic structural diagram of a heater according to another embodiment;

FIG. 8 is a schematic structural diagram of a heater according to another embodiment;

FIG. 9 is a schematic structural diagram of a heater according to another embodiment;

FIG. 10 is a schematic structural diagram of a heater according to another embodiment;

FIG. 11 is a schematic structural diagram of a support member in FIG. 10 from another perspective;

FIG. 12 is a schematic structural diagram of a heater according to another embodiment;

FIG. 13 is a schematic structural diagram of a support member in FIG. 12 from another perspective;

FIG. 14 is a schematic structural diagram of a heater according to another embodiment;

FIG. 15 is a schematic diagram of a support member according to another embodiment;

FIG. 16 is a schematic diagram of a preparation method of a heater according to an embodiment; and

FIG. 17 is a schematic diagram of a preparation method of a heater according to another embodiment.

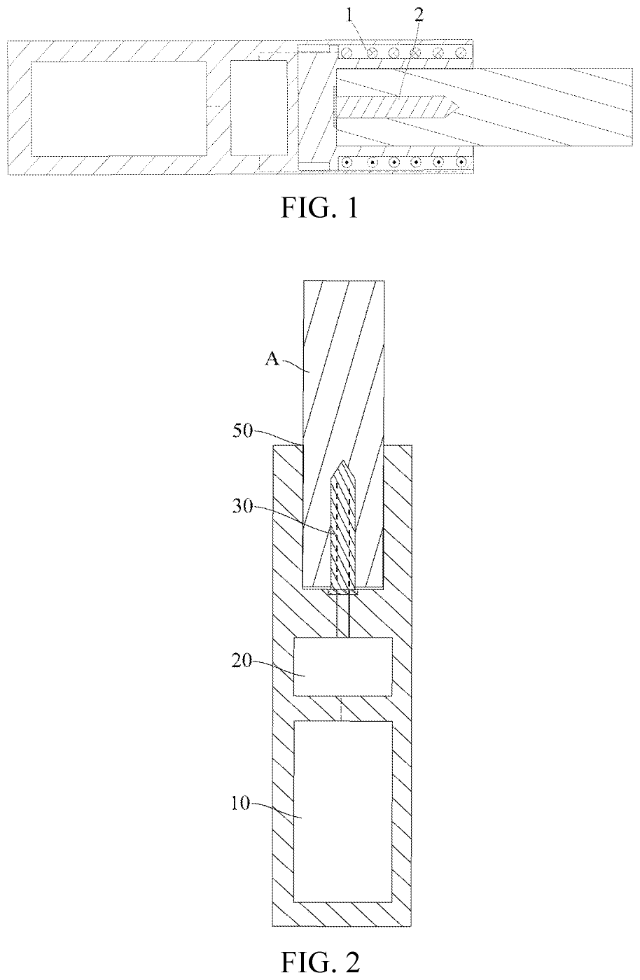

### DETAILED DESCRIPTION

For ease of understanding of this application, this application is described in further detail below with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

An embodiment of this application provides an aerosol generation device. For construction thereof, reference may be made to FIG. 2 to FIG. 4. The aerosol generation device includes:
a cavity (not shown in the figure), having an opening 50, where an aerosol-forming product A, for example, a cigarette, is removably received in the cavity through the opening 50, and the cavity is a semi-enclosed space in communication to the opening 50 in FIG. 2;
a heater 30, at least partially extending in the cavity, to heat the aerosol-forming product A, for example, the cigarette, so that at least one component of the aerosol-forming product A is evaporated, to form an aerosol for inhalation;
a core 10, being a rechargeable direct current core, and being capable of outputting a direct current; and
a circuit 20, appropriately electrically connected to the rechargeable core 10, and configured to guide a current between the core 10 and the heater 30.

In a preferred embodiment, a direct-current voltage provided by the core 10 ranges from about 2.5 V to about 9.0 V, and the direct current provided by the core 10 ranges from about 2.5 A to about 20 A.

In a preferred embodiment, the heater 30 is generally in a pin or needle or column or rod shape, which is advantageous for insertion into the aerosol-forming product A. In addition, the heater 30 may be about 12 millimeters to 19 millimeters in length, and be about 2.0 mm to 2.6 mm in diameter.

In addition, after assembly, the heater 30 in the pin or needle shape approximately includes a free front end in a tip end or conical shape, exposed in the cavity, for ease of the insertion into the aerosol-forming product A; and the heater 30 further includes a rear end away from the free front end, for ease of being clamped or held by the aerosol generation device for mounting and fixing.

Further, in an optional embodiment, a tobacco-containing material releasing a volatile compound from a substrate when heated is preferably used for the aerosol-forming product A. Alternatively, a non-tobacco material that can be heated and then be suitable for electrically heated smoking may be used. A solid substrate that may include one or more of powder, a granule, a fragment, a thin strip, a strip, or a sheet of one or more of a vanilla leaf, a tobacco leaf, homogeneous tobacco, and expanded tobacco, may be used for the aerosol-forming product A. Alternatively, the solid substrate may include an appended tobacco or non-tobacco volatile aroma compound, to be released when the substrate is heated.

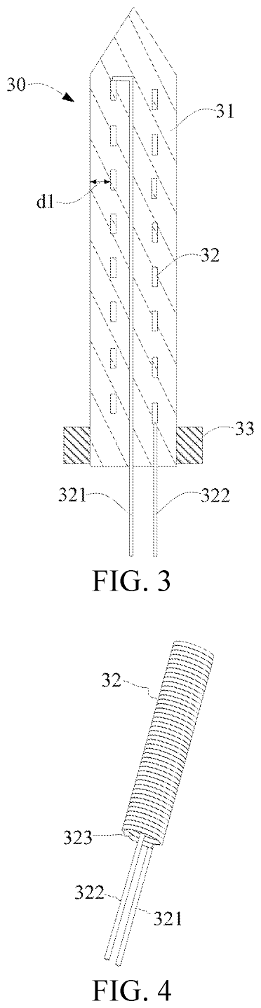

According to a preferred embodiment shown in FIG. 3, a heater 30 is a resistance heater, including:
a resistance heating coil 32; and
a heat conductor 31, where the heat conductor 31 is formed from a moldable material; and
specifically, the moldable material is molded around and in a hollow of the resistance heating coil 32 to be coupled on to the resistance heating coil 32, and totally wraps the resistance heating coil 32, so that the resistance heating coil 32 is buried or embedded in the heat conductor 31. During use, the heat conductor 31 conducts heat of the resistance heating coil 32 to heat an aerosol-forming product A.

In a preferred implementation, the resistance heating coil 32 is prepared by using a commonly used resistive metal or alloy material, such as stainless steel, a nickel-chromium alloy, an iron-chromium-aluminum alloy, or metal titanium.

In a more preferred implementation, if the resistance heating coil 32 is prepared by using a material with a positive resistance temperature coefficient or a negative resistance temperature coefficient that has a correlation between a temperature and resistance, resistance of the resistance heating coil 32 may be detected during use to determine a temperature of the resistance heating coil 32.

In a preferred implementation as shown in FIG. 3 to FIG. 5, the resistance heating coil 32 has about 6 to 20 windings or turns. In addition, the resistance heating coil 32 is about 8 mm to 12 mm in extension length. A spiral tube constructed from the resistance heating coil 32 is about 1 mm to 3 mm in outer diameter, and is about 0.5 mm to 1.5 mm in inner diameter. In addition, the resistance heating coil 32 has a resistance value of about 0.8 ohms to 1.5 ohms.

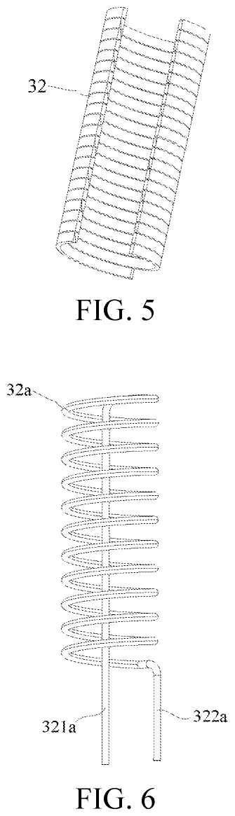

Further, refer to FIG. 4 and FIG. 5, a section shape of a conducting wire material of the resistance heating coil 32 is different from a regular circular shape, and instead, is a broad or flat shape. In the section shape shown in FIG. 5, a section of the conducting wire material of the resistance heating coil 32 has an axial extension size greater than a radial extension size, so that the section of the conducting wire material of the resistance heating coil 32 is in a flat rectangular shape. To be simple, compared with a regular spiral heating coil formed from a conducting wire with a circular section, the foregoing constructed resistance heating coil 32 has a totally or at least flattened form of the conducting wire material. Therefore, the conducting wire material extends in a radial direction to a small extent. This measure is advantageous for improving transferring efficiency of heat.

In an implementation shown in FIG. 5, an extension size of the section of the conducting wire material of the resistance heating coil 32 in an axial direction of a spiral coil is approximately between 0.5 mm and 4 mm; and an extension size of the conducting wire material of the resistance heating coil 32 in a radial direction of the spiral coil is approximately between 0.05 mm and 0.5 mm.

Alternatively, in another variation implementation shown in FIG. 6, a cross-section of a conducting wire material of a resistance heating coil 32a is circular.

Further, as shown in FIG. 4, the following is further arranged on the resistance heating coil 32:
a first conductive pin 321 and a second conductive pin 322. During use, the first conductive pin 321 and the second conductive pin 322 are connected to the circuit 20, to provide an alternating current for the resistance heating coil 32. The first conductive pin 321 is welded to an upper end of the resistance heating coil 32 and then penetrates through an inner hollow 323 of the resistance heating coil 32 to a lower end, thereby facilitating connection and assembly with the circuit 20, and the like. The second conductive pin 322 is directly connected to the lower end of the resistance heating coil 32.

In another variation implementation, the first conductive pin 321 may be further located in an exterior of the resistance heating coil 32, and extends from the upper end to the lower end in the axial direction of the resistance heating coil 32, thereby facilitating connection to the circuit 20.

Alternatively, in another variation implementation, different couple wire materials are respectively used for the first conductive pin 321 and the second conductive pin 322, so that a thermocouple configured to detect the temperature of the resistance heating coil 32 may be formed between the first conductive pin 321 and the second conductive pin 322. For example, the first conductive pin 321 and the second conductive pin 322 are prepared by using two different materials among galvanic materials such as nickel, a nickel-chromium alloy, a nickel-silicon alloy, nickel-chromium-constantan, constantan copper, and ferrochromium.

In another preferred implementation, the heat conductor 31 is prepared by using a non-metal inorganic material, for example, an insulating material such as a metal oxide (such as MgO, Al₂O₃, or B₂O₃) or a metal nitride (such as Si₃N₄, B₃N₄, or Al₃N₄), or another highly heat-conductive composite ceramic material. During preparation, the non-metallic inorganic material is mixed with an organic additive commonly used in an injection molding process to prepare a slurry, and then through an in-mold injection molding process, the slurry is molded inside and outside the resistance heating coil 32/32a to form the heat conductor 31.

In another optional implementation, the foregoing heat conductor 31 is formed by molding a heat-conductive metal or alloy material that may be prepared through a powder metallurgy technology. In some embodiments, the heat-conductive metal or alloy material is preferably a material with a melting point lower than 800 degrees, such as Al with a melting point of 670 degrees or AlCu with a melting point of 640 degrees, which may reduce a temperature of a metal in injection molding. Therefore, in preparation, raw material powder of the foregoing metal or alloy is mixed with an organic additive for powder metallurgy to form injection feeding, and then the injection feeding is molded inside and outside the resistance heating coil 32/32a to form the heat conductor 31.

In another optional implementation, the heat conductor 31 is a metal material. Alternatively, the heat conductor 31 includes a metal. In a preferred implementation, a thermal conductivity of the metal material of the heat conductor 31 is greater than 80 W/(m·K). During use, the heat conductor 31 has a fast temperature response for heat transfer, and a temperature field on a surface is uniform.

In addition, a metal or metal alloy that is of the heat conductor 31 and has a melting point ranging from 300° C. to 1900° C. is advantageous for melting preparation. Preferably, the metal material for forming the heat conductor 31 may be a plurality of or at least one of metal materials such as aluminum and an aluminum alloy, copper and a copper alloy, magnesium and a magnesium alloy, zinc and a zinc alloy, titanium and a titanium alloy, silver and a silver alloy, gold and a gold alloy, iron and an iron alloy, nickel and a nickel alloy, tin and a tin alloy, zirconium and a zirconium alloy, cobalt and a cobalt alloy, platinum and a platinum alloy, manganese and a manganese alloy, and vanadium and a vanadium alloy. In addition, in some implementations, the metal material of the heat conductor 31 includes metals with high thermal conductivities, such as aluminum, copper, and magnesium, or an alloy of the metals. More typically, the thermal conductivity of the heat conductor 31 is between 100 W/(m·K) to 300 W/(m·K).

In addition, in a radial direction of the heater 30, as shown in FIG. 3, a distance d1 between an outer surface of the heater 30 defined by the heat conductor 31 and the resistance heating coil 32 is approximately between 0.001 mm to 2.3 mm. Preferably, the distance d1 between the outer surface of the heater 30 and the resistance heating coil 32 is approximately between 0.2 mm to 1.0 mm.

In some regular implementations, the heat conductor 31 cooled and solidified from a molten liquid in a mold cavity of a mold may have any appropriate cross-section, for example, an arc-shaped cross-section such as a circular, elliptical, or multi-arc combination cross-section; a polygonal cross-section such as a square, rectangular, triangular, hexagonal, octagonal, or decagonal cross-section; or a cross-section in a multi-pointed star form such as a cross-section in a three-pointed star, four-pointed star, five-pointed star, six-pointed star, eight-pointed star, or ten-pointed star form. Preferably, a cross-section of the heater 30 defined by the heat conductor 31 is in a circular shape.

Correspondingly, a cross-section of the spiral resistance heating coil 32 may be correspondingly a polygonal cross-section such as a circular, square, rectangular, triangular, hexagonal, octagonal, or decagonal cross-section.

In addition, in some implementations, a distance between adjacent windings or turns of the resistance heating coil 32 is constant in the axial direction. Alternatively, in some other variation implementations, a distance between adjacent windings or turns of the resistance heating coil 32 is variable in the axial direction, for example, the distance gradually increases or decreases in the axial direction.

In addition, in some implementations, an outer diameter of the resistance heating coil 32 is constant in the axial direction. Alternatively, in some other variation implementations, an outer diameter of the resistance heating coil 32 is variable. For example, the outer diameter of the resistance heating coil 32 gradually increases or gradually in the axial direction, so that the resistance heating coil 32 is in a conical shape.

In the foregoing implementations, when the heat conductor 31 is the metal or alloy, the resistance heating coil 32/32a needs to be surface-insulated. For example, in a preferred implementation, a process method such as vacuum evaporation or thermal spraying is used on a surface of the resistance heating coil 32/32a to deposit or spray an insulating material on the surface to form an insulating layer. In some optional implementations, the insulating material of the insulating layer is preferably a food-safe, temperature-resistant material with a thermal expansion coefficient difference within 10%, for example, a material such as 340 stainless steel or silicate, for insulation. In some optional implementations, the insulating material of the insulating layer is preferably an insulating material such as a metal oxide (such as MgO, Al₂O₃, or B₂O₃) with an excellent thermal conductivity or a metal nitride (such as Si₃N₄, B₃N₄, or Al₃N₄), or is optionally a high-temperature-resistant glass glaze. For example, preferably, a melting point temperature of glass powder is higher than 800° C., and a minimum thereof is not lower than 450° C.

For the foregoing heater 30, in another embodiment shown in FIG. 3, the heater 30 is an electromagnetic induction heater, including:
an induction coil 32; and
a susceptor 31, where the susceptor 31 is coupled on to the induction coil 32 by molding a sensing material around and in a hollow of the induction coil 32, and totally wraps the induction coil 32, so that the induction coil 32 is buried or embedded in the susceptor 31.

In the foregoing aerosol generation device, the susceptor is formed and is integrated into one body on the induction coil by molding, which is advantageous for miniaturization of the device.

If the induction coil 32 is buried or embedded in the susceptor 31, a magnetic field generated by the induction coil 32 is totally absorbed or shielded by the susceptor 31, which is advantageous for preventing a magnetic leakage outside the heater 30. During use, there is basically no magnetic leakage outside the heater 31.

Therefore, in an implementation, a circuit 20 is appropriately electrically connected to a rechargeable core 10, and is configured to convert a direct current outputted by the core 10 into an alternating current with an appropriate frequency and supply the alternating current to the induction coil 32, to enable the induction coil 32 to generate a variable magnetic field. The susceptor 31 is penetrated by the variable magnetic field to generate heat. In a more preferred implementation, the frequency of the alternating current supplied by the circuit 20 to the induction coil ranges from 80 KHz to 400 KHz; and more specifically, the frequency may range from about 200 KHz to 300 KHz.

In a preferred implementation, the susceptor 31 is obtained by molding a sensing metal or alloy on the induction coil 32 through powder metallurgy. Specifically, raw material powder of the sensing metal or alloy is mixed with an organic additive to form injection feeding, and then the injection feeding is coupled inside and outside the resistance heating coil 32 in a mold through injection molding, and is then sintered to obtain the foregoing heater 30.

In some preferred implementations, the sensing metal or alloy of the susceptor 31 includes 430-grade stainless steel (SS430), 420-grade stainless steel (SS420), an alloy material (such as permalloy) containing iron and nickel, or the like.

In this implementation, a surface of the induction coil 32 may be insulated before preparation, so that the induction coil 32 and the molded susceptor 31 are insulated from each other. In a preferred implementation, insulation is provided by forming an insulating layer on the surface of the induction coil 32. In some implementations, a material of the insulating layer may be a food-safe, temperature-resistant material with a thermal expansion coefficient difference within 10% as described above.

In a preferred implementation, the induction coil 32 may be obtained by using a conducting wire material with a flat cross-section in FIG. 5 for preparation. Therefore, the conducting wire material extends in a radial direction to a small extent. This measure is advantageous for increasing a current and improving magnetic strength. In an embodiment, the cross-section of the conducting wire material of the induction coil 32 is in a flat shape with an axial extension size greater than a radial extension size. Alternatively, in another variation implementation, the cross-section of the conducting wire material of the induction coil 32 is in a flat shape with a radial extension size greater than an axial extension size.

In a preferred implementation as shown in FIG. 3 to FIG. 5, the induction coil 32 has about 6 to 20 windings or turns. In addition, the induction coil 32 is about 8 mm to 12 mm in extension length. A spiral tube constructed from the induction coil 32 is about 1 mm to 3 mm in outer diameter, and is about 0.5 mm to 1.5 mm in inner diameter.

Alternatively, in another variation implementation shown in FIG. 6, a cross-section of a conducting wire material of an induction coil 32a is circular.

In some regular implementations, a material of the induction coil 32 is prepared by using a low-resistance metal material such as copper, gold, or silver.

Alternatively, in a similar implementation, a material of the induction coil 32 is preferably prepared by using a material with a positive or negative resistance temperature coefficient, for example, a nickel-aluminum alloy, a nickel-silicon alloy, a palladium-containing alloy, or a platinum-containing alloy. During use, resistance of the induction coil 32 may be detected to determine a temperature of a sensor 30.

Alternatively, in a similar implementation, different couple wire materials are respectively used for the first conductive pin 321 and the second conductive pin 322 that supply power to the induction coil 32/32a, so that a thermocouple configured to detect the temperature of the heater 30 may be formed between the first conductive pin 321 and the second conductive pin 322. For example, the first conductive pin 321 and the second conductive pin 322 are prepared by using two different materials among galvanic materials such as nickel, a nickel-chromium alloy, a nickel-silicon alloy, nickel-chromium-constantan, constantan copper, and ferrochromium.

Alternatively, in a similar implementation, a first conductive pin 321 and a second conductive pin 322. During use, the first conductive pin 321 and the second conductive pin 322 are connected to the circuit 20, to provide an alternating current for the induction coil 32. The first conductive pin 321 is welded to an upper end of the induction coil 32 and then penetrates through an inner hollow 323 of the induction coil 32 to a lower end, thereby facilitating connection and assembly with the circuit 20, and the like. The second conductive pin 322 is directly connected to the lower end of the induction coil 32.

In another variation implementation, the first conductive pin 321 may be further located in an exterior of the induction coil 32, and extends from the upper end to the lower end in the axial direction of the induction coil 32, thereby facilitating connection to the circuit 20.

In another variation implementation, the heater 30 includes:
a base body 31 surrounding or enclosing the induction coil 32 by molding, for example, the foregoing non-metal inorganic material, for example, an insulating material such as a metal oxide (such as MgO, Al₂O₃, or B₂O₃) or a metal nitride (such as Si₃N₄, B₃N₄, or Al₃N₄), or another highly heat-conductive composite ceramic material;
and a sensing coating (not shown in the figure) formed on the molded base body 31 by deposition, spraying, printing, or the like, where heat is generated by the sensing coating in a magnetic field of the induction coil 32.

In this embodiment, heat is generated only by the sensing coating formed on the surface of the base body obtained by molding, and compared with an integrally molded susceptor, there is better convenience. Similarly, the sensing coating is prepared by using the sensing material described above.

Alternatively, for the foregoing heater 30, in another embodiment shown in FIG. 3, the heater 30 is an electromagnetic induction heater, including:
an induction coil 32; and
a heat conductor 31, where the heat conductor 31 is coupled on to the induction coil 32 by molding a heat-conductive material around and in a hollow of the induction coil 32, and totally wraps the induction coil 32, so that the induction coil 32 is buried or embedded in the heat conductor 31.

In this embodiment, the induction coil 32 is prepared by using a conductive sensing material, for example, a conductive ferromagnetic or ferrimagnetic material. When an AC alternating current is provided by a circuit 20 to the induction coil 32, the induction coil 32 can perform resistance Joule heating, and in addition, the induction coil 32 generates a variable magnetic field and is penetrated by the magnetic field to form electromagnetic induction heating. In this embodiment, a material of the induction coil 32 is the conductive ferromagnetic or ferrimagnetic material. For example, the induction coil 32 is an iron-nickel-cobalt alloy (for example, Kovar or an iron-nickel-cobalt alloy 1), armco-iron, permalloy (for example, permalloy C), or ferritic or martensitic stainless steel.

In this embodiment, resistance of the induction coil 32 may be controlled to be between about 10 mΩ to 1500 mΩ.

In this implementation, a non-metal or non-sensing heat-conductive material, such as a metal oxide (such as MgO, Al₂O₃, or B₂O₃) with an excellent thermal conductivity or a metal nitride (such as Si₃N₄, B₃N₄, or Al₃N₄), or optionally a high-temperature-resistant glass glaze, is used for the heat conductor 31.

In this implementation, a shape, a size, or the like of the conducting wire material described above may also be used for the induction coil 32.

Further, in a preferred implementation shown in FIG. 3, a free front end of the heater 30 in a pin or needle shape is in a conical tip shape, which is advantageous for insertion into an aerosol-forming product A. Further, as shown in FIG. 3, the heater 30 is at a rear end away from a tip end, and a base or flange 33 surrounding or coupled on to the heat conductor 31 is further arranged on the heater 30; and in the aerosol generation device, the base or flange 33 may be clamped or held, so that the heater 30 can be stably held in the aerosol generation device. In the figure, a heat-resistant material such as an inorganic material ceramic, a metal, glass, or quartz is generally used for the base or flange 33. For example, PEEK, a ZrO₂ ceramic, or an Al₂O₃ ceramic. In preparation, the base or flange 33 is fixed on the rear end of the heater 30 through high-temperature adhesive bonding, molding such as in-mold injection molding, or welding, and a fixed connection is kept, so that an aerosol generation device may support, clamp, or hold the base or flange 33 to stably mount and hold the heater 30.

In addition, as shown in FIG. 3, the heat conductor 31 that is molten and solidified is partially located outside the resistance heating coil 32, and is partially located inside the resistance heating coil 32. In other words, the heat conductor 31 includes both a part located outside the resistance heating coil 32 and a part located inside the resistance heating coil 32, instead of just the part located outside the resistance heating coil 32.

Further, as shown in the figure, a cross-sectional area or an outer diameter of the base or flange 33 is greater than a cross-sectional area or an outer diameter of the susceptor 31/heat conductor 31. Further, according to a preferred implementation shown in FIG. 3 and FIG. 4, after the base or flange 33 is assembled at the rear end of the heater 30, the first conductive pin 321 and the second conductive pin 322 penetrate from the base or flange 33, for ease of connection to the circuit 20.

Further, in a more preferred implementation, a high heat-conductive or/and high radiation material coating may be formed on a surface of the prepared heater 30. To improve uniformity of a temperature field on the surface of the heater 30, heat exchange efficiency between the heater 30 and the aerosol-forming product A is improved. In some optional implementations, for the high heat-conductive or/and high radiation material on the surface of the heater 30, such as a metal material Al, Cu, or Au, a carbene material, a carbide, or a nitride, a process such as electroplating, printing, coating, thermal spraying, or evaporation may be selected based on a difference in material attribute.

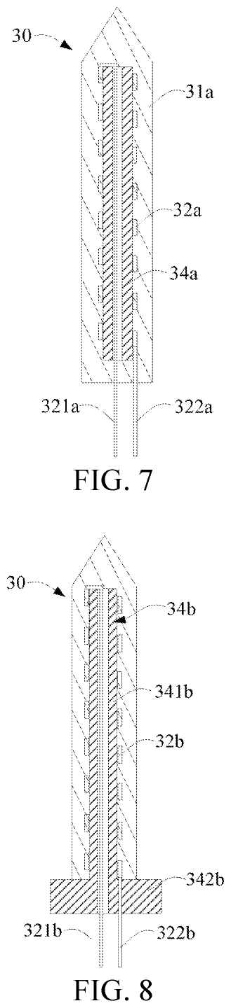

Alternatively, FIG. 7 is a schematic diagram of a heater 30 according to another variation embodiment. The heater 30 in this embodiment includes:

a support member 34a, constructed in an elongated tubular shape in this preferred implementation, and located in a resistance heating coil 32a during assembly, to provide support to the resistance heating coil 32a on an inner side of the resistance heating coil 32a.

In the heater 30 in this embodiment, arranging the tubular support member 34a in the resistance heating coil 32a is advantageous for stable holding and positioning of the resistance heating coil 32a during preparation. In addition, a first conductive pin 321a connected to a first end of the resistance heating coil 32a penetrates the tubular support member 34a.

In addition, in some implementations, the support member 34a is prepared by using various appropriate materials such as a ceramic, a metal, a fiber such as a carbon fiber, glass, quartz, graphite, silicon carbide, and silicon nitride.

In addition, the heat conductor 31a is formed in a manner in which a heat-conductive metal material is heated into a molten liquid and is then solidified surrounding the resistance heating coil 32a and/or the support member 34a; and the heat conductor 31a at least partially defines an outer surface of the heater 30.

In addition, in some other variation implementations, the support member 34a is rod-shaped or bar-shaped. Correspondingly, both the first conductive pin 321a and the second conductive pin 322a during assembly are located on an outer side of the rod-shaped or bar-shaped support member 34a.

Alternatively, in some other variation implementations, FIG. 8 is a schematic diagram of a support member 34b providing support in a resistance heating coil 32b in another embodiment. In this embodiment, the support member 34b includes: a section 341b and a section 342b that are in different outer diameters. An outer diameter of the section 342b is greater than an outer diameter of the section 341b. The section 341b is close to a free front end, and the section 342b is close to a rear end.

In addition, during assembly, the resistance heating coil 32b is fixed surrounding or wrapping outside the section 341b of the support member 34b; and the outer diameter of the section 342b is greater than the outer diameter of the section 341b, so that a step is formed between the section 342b and the section 341b. During assembly, a lower end of the resistance heating coil 32b abuts against the step formed at the section 342b to provide a stop.

Correspondingly, in a variation embodiment in FIG. 8, a heat conductor 31b is solidified and formed surrounding the resistance heating coil 32b and/or outside the section 341b of the support member 34b. The heat conductor 31b avoids the section 342b. In addition, in this implementation, the section 342b is exposed or located outside the heat conductor 31b. In addition, for the section 342b, in a preferred implementation in FIG. 8, the outer diameter of the section 342b is greater than an outer diameter of the heat conductor 31b, so that the section 342b is at least partially protruding relative to the heat conductor 31b in a radial direction. Therefore, during use, the section 342b at least partially defines a base or flange for mounting and fixing of the heater 30. During assembly, in the aerosol generation device, the section 342b is clamped, so that the heater 30 is stably mounted and fixed.

Alternatively, in some other variation implementations, the outer diameter of the section 342b is the same as the outer diameter of the heat conductor 31b.

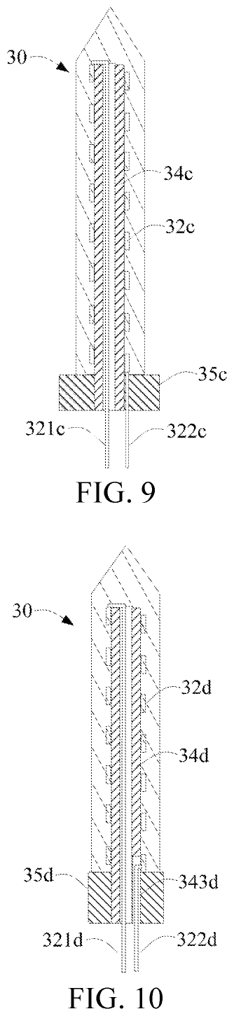

Alternatively, in another variation embodiment, for example, a heater 30 shown in FIG. 9 includes:
a support member 34c, being in a tubular shape, a rob shape, or the like, where a length of the support member 34c is greater than a length of a resistance heating coil 32c; and
a base or flange 35c, separately prepared from the support member 34c, where the base or flange 35c is fixed surrounding and coupled outside the support member 34c at a rear end of the heater 30; in preparation, the resistance heating coil 32c surrounds the support member 34c and avoids the base or flange 35c; a lower end of the resistance heating coil 32c abuts against the base or flange 35c;
a heat conductor 31c surrounds the support member 34c and/or the resistance heating coil 32c; the heat conductor 31c also avoids the base or flange 35c in a longitudinal direction; and an outer diameter of the base or flange 35c is greater than that of the heat conductor 31c, so that the base or flange 35c is at least partially protruding and exposed relative to the heat conductor 31c in a radial direction; and the base or flange 35c is clamped or held during assembly to mount and fix the heater 30. In addition, in this implementation, a first conductive pin 321c may penetrate through the tubular support member 34c, or is located outside the tubular/rob-shaped support member 34c. In addition, a second conductive pin 322c may penetrate the base or flange 35c, or penetrate between the base or flange 35c and the support member 34c.

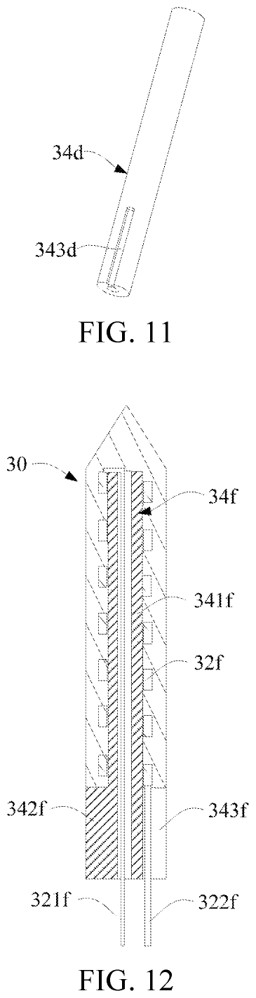

Alternatively, FIG. 10 and FIG. 11 are schematic diagrams of a heater 30 according to another variation embodiment. In this embodiment, a groove 343d extending in a length direction is provided on a surface of a tubular or rod-shaped support member 34d that is configured to support a resistance heating coil 32d from an inner side. During assembly, a second conductive pin 322d connected to a lower end of the resistance heating coil 32d is at least partially accommodated and held in the groove 343d; and the second conductive pin 322d welded to the lower end of the resistance heating coil 32d at least partially extends in the groove 343d.

In addition, further, in the embodiment shown in FIG. 10, a base or flange 35d of the heater 30 surrounds the groove 343d.

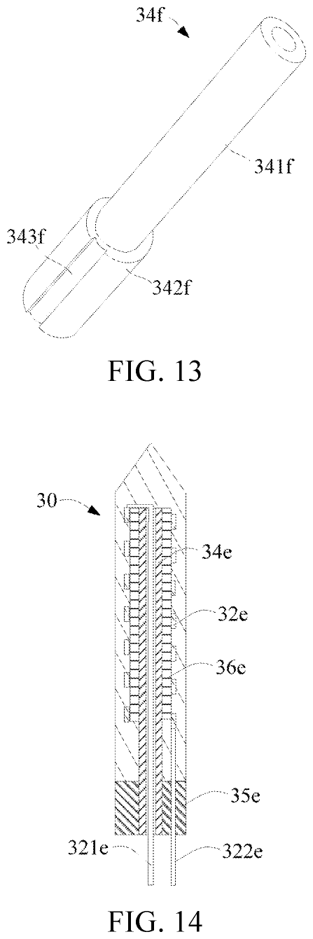

Alternatively, further, FIG. 12 and FIG. 13 are schematic diagrams of a heater 30 according to another variation embodiment. In the heater 30 in this embodiment, a support member 34f includes a section 341f and a section 342f. A length of the section 341f is greater than a length of the section 342f, and an outer diameter of the section 341f is less than an outer diameter of the section 342f. During assembly, a resistance heating coil 32f surrounds and winds outside the section 341f, and a lower end abuts against the section 342f to form a stop.

In addition, a groove 343f extending in an axial direction is provided on a surface of the section 342f, and is configured to accommodate and hold a second conductive pin 322f in an implementation.

In addition, a heat conductor 31f is cooled and solidified from a molten liquid outside the resistance heating coil 32f and the section 341f of the support member 34f; the heat conductor 31f defines at least a part of an outer surface of the heater 30; and the heat conductor 31f avoids the section 342f.

In addition, the section 342f is exposed outside the heat conductor 31f; and the outer diameter of the section 342f is basically the same as an outer diameter of the heat conductor 31f.

Alternatively, in some other variation implementations, an axially penetrating through hole is provided on the section 342f, so that the second conductive pin 322f penetrates the through hole of the section 342f to extend beyond a rear end.

Alternatively, FIG. 14 is a schematic diagram of a heater 30 according to another variation embodiment. The heater 30 in this embodiment includes:
a first tubular support member 34e, and a second tubular support member 36e, where the first support member 34e is located inside the second support member 36e, or the second support member 36e surrounds outside the first support member 34e; and an extension length of the first support member 34e is greater than an extension length of the second support member 36e, so that at least a part of the first support member 34e close to a rear end extends beyond the second support member 36e;
a base or flange 35e, surrounding the first support member 34e at the rear end;
a resistance heating coil 32e, winding or surrounding outside the second support member 36e; a first conductive pin 321e connected to an upper end of the resistance heating coil 32e and penetrating through a hollow of the first support member 34e to the rear end; a second conductive pin 322e connected to a lower end of the resistance heating coil 32e; and
a heat conductor 31c, cooled and solidified from a molten liquid outside the resistance heating coil 32e, the first support member 34e, and the second support member 36e, where the heat conductor 31e defines at least a part of an outer surface of the heater 30; and the heat conductor 31c avoids the base or flange 35e.

In addition, an outer diameter of the heat conductor 31e is basically the same as that of the base or flange 35e.

In addition, the resistance heating coil 32e is separated from the base or flange 35e, and a distance is kept between the resistance heating coil 32 and the base or flange 35e without contact.

In a regular implementation, a ceramic is generally used for the base or flange 35e.

In the foregoing embodiment, a metal alloy, a fiber such as a carbon fiber, or the like is preferably used for the first support member 34e; and a material such as a ceramic, quartz, silicon carbide, or silicon nitride is used for the second support member 36e.

Alternatively, in some other variation implementations, an extension length of the second support member 36e is greater. For example, the second support member 36e extends until abutting against the base or flange 35e.

Alternatively, in some other variation implementations, a groove extending in an axial direction is provided on an outer surface of the base or flange 35e, or an axially penetrating through hole is provided on the base or flange 35e; and the second conductive pin 322e at least partially penetrates the groove or through hole on the base or flange 35e. This is advantageous for assembly and fixing of the second conductive pin 322e.

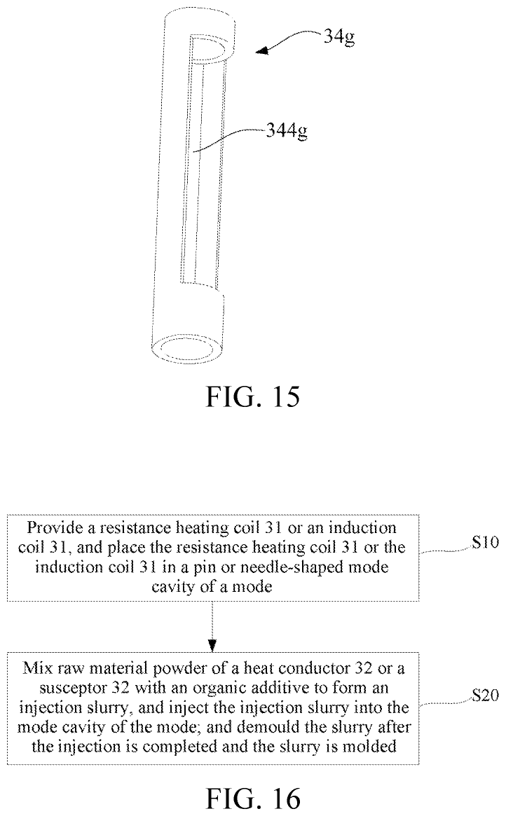

Alternatively, FIG. 15 is a schematic diagram of a support member 34g according to another variation embodiment. In this embodiment, the support member 34g is a longitudinally extending tubular or cylindrical shape; and one or a plurality of through holes or hollow holes 344g are provided on a tube wall of the support member 34g. A resistance heating coil 32 surrounds or winds outside the support member 34g; and the through hole or hollow hole 344g is configured to provide a channel for a molten liquid precursor of a heat conductor 31 to flow or enter into the support member 34g, so that the molten liquid precursor enters the support member 34g and solidifies.

Alternatively, similarly, in some other implementations, a groove configured to accommodate and hold a second conductive pin 322 is further provided on an outer surface of the support member 34g.

Another embodiment of this application further provides a method for preparing the foregoing heater 30. Referring to FIG. 16, steps of the method include the following steps.

S10: Provide a resistance heating coil 31 or an induction coil 31, and place the resistance heating coil 31 or the induction coil 31 in a pin or needle-shaped mode cavity of a mode.

S20: Mix raw material powder of a heat conductor 32 or a susceptor 32 with an organic additive to form an injection slurry, and inject the injection slurry into the mode cavity of the mode to enable the slurry to fill the mold cavity and totally wrap the resistance heating coil 31 or the induction coil 31; and obtain a heater 30 after the injection is completed and the slurry is molded and demoulded.

Certainly, in the foregoing preparation method step S20, according to a molding process, the molded heat conductor 32 or the susceptor 32 can be totally bonded and solidified by sintering after demoulding.

In the foregoing implementation, an additive product commonly used in a powder metallurgy process may be used for the organic additive, and may be purchased directly from the market. In some implementations, the organic additive mainly includes a molding component and a solvent component; for example, the molding component may include at least one of the following commonly used molding agents: isophorone diisocyanate 50-60, polycarbonate diol 70-75, dibutyltin dilaurate 1-2, 1,4-butanediol 3-4, rosin 10-13, tetraethoxysilane 30-40, phthalic anhydride 4-7, triethanolamine 5-8, p-toluenesulfonic acid 0.01-0.02, wax such as paraffin, and a polymer such as polyethylene or polyoxymethylene; and the solvent component may include at least one of water, ethanol, dimethyl carbonate, cyclohexanone, tetrahydrofuran, toluene and xylene, a fatty acid, and the like.

In a preferred implementation, a surface of the heater 30 is defined by the molded heat conductor 32 or the susceptor 32.

Further, in a preferred implementation, in the foregoing heater 30, the resistance heating coil 31 or the induction coil 31 is totally embedded or wrapped in an inner part of the heat conductor 32 or the susceptor 32, and is therefore not exposed. Only a first conductive pin 321 and a second conductive pin 322 are exposed outside the heat conductor 32 or the susceptor 32.

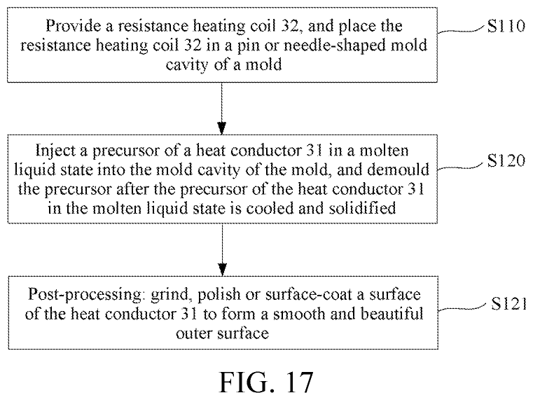

Another embodiment of this application further provides another method for preparing the foregoing heater 30. Referring to FIG. 17, steps of the method include the following steps.

S110: Obtain a resistance heating coil 32 through preparation by conducting wire winding, and connect a first conductive pin 321 and a second conductive pin 322 to two ends of the resistance heating coil 32 by welding or the like, where
the resistance heating coil 32 is placed in a mold with a pin or needle-shaped mold cavity.

S120: Heat a precursor of a heat conductor 31, such as metal raw material powder configured to form the heat conductor 31, to a molten liquid state, and inject the precursor in the molten liquid state into the mold cavity of the mold, so that the precursor of the heat conductor 31 in the molten liquid state is cooled and solidified to form the heat conductor 31 that wraps or surrounds the resistance heating coil 32; and demould the heat conductor 31 to obtain the heater 30.

In a more preferred implementation, a surface of the resistance heating coil 32 in step S110 includes an insulating layer, so that the resistance heating coil 32 is insulated from the metal heat conductor 31. The insulating layer of the surface of the resistance heating coil 32 is, for example, an oxidized insulating layer formed by surface oxidation, or an insulating coating such as a glaze layer, formed by spraying, deposition, or the like.

In addition, in step S120, generally, the precursor of the heat conductor 31 may be heated to a temperature greater than 700° C., and the process is kept for more than 0.1 h to totally melt the precursor, and then pressure is applied to a molten liquid metal melt through a device and the mold, so that the molten liquid metal melt flows into the mold cavity through an intermediate channel under specified pressure, and fully fills a space of the mold cavity and a space gap in the resistance heating coil 32. After a temperature is kept for a period of time, such as 0.02 h, interfaces between the mold cavity and the resistance heating coil closely totally fit. Finally, the mold and the precursor of the liquid heat conductor 31 are cooled at a specified rate, so that the molten liquid metal melt is cooled, solidified, and molded, forming a close fit and dense and strong combination with the resistance heating coil 32.

In addition, in a more preferred implementation, after step S120, the method further includes:

S121: Post-processing: grind, polish or surface-coat a surface of the heat conductor 31 to form a smooth and beautiful outer surface.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. An aerosol generation device, configured to heat an aerosol-forming product to generate an aerosol, and comprising:
a cavity, configured to receive the aerosol-forming product; and
a heater, at least partially extending in the cavity, to heat the aerosol-forming product received in the cavity, wherein the heater comprises:
an induction coil, configured to generate a variable magnetic field; and
a susceptor, configured to be penetrated by the variable magnetic field to generate heat, wherein the susceptor is formed by molding a moldable sensing material on the induction coil, and wraps the induction coil.

2. The aerosol generation device according to claim 1, wherein the induction coil is buried or embedded in the susceptor.

3. The aerosol generation device according to claim 1, wherein the induction coil is not exposed outside the susceptor.

4. The aerosol generation device according to claim 1, wherein the induction coil is constructed in a form of a spiral coil extending in an axial direction of the heater; and
a section of a conducting wire material of the induction coil is constructed to be in a flat shape.

5. The aerosol generation device according to claim 4, wherein the section of the conducting wire material of the induction coil is constructed to have an extension size in an axial direction of the induction coil greater than an extension size in a radial direction.

6. The aerosol generation device according to claim 1, wherein the heater further comprises:
a conductive pin, connected to the induction coil, to supply power to the induction coil,
wherein the conductive pin at least partially penetrates from the inside of the susceptor to the outside of the susceptor.

7. The aerosol generation device according to claim 6, wherein the conductive pin comprises a first conductive pin and a second conductive pin that are of different materials, to form, between the first conductive pin and the second conductive pin, a thermocouple configured to sense a temperature of the heater.

8. The aerosol generation device according to claim 1, wherein the variable magnetic field is basically limited in the susceptor.

9. The aerosol generation device according to claim 1, wherein the variable magnetic field basically has no magnetic leakage outside the susceptor.

10. The aerosol generation device according to claim 1, wherein the induction coil has 6 to 20 windings or turns.

11. The aerosol generation device according to claim 1, wherein the induction coil has an extension length of 8 mm to 12 mm, an outer diameter of 1 mm to 3 mm, and an inner diameter of 0.5 mm to 1.5 mm.

12. An aerosol generation device, configured to heat an aerosol-forming product to generate an aerosol, and comprising:
a cavity, configured to receive the aerosol-forming product; and
a heater, at least partially extending in the cavity, to heat the aerosol-forming product received in the cavity, wherein the heater comprises:
an induction coil, configured to generate a variable magnetic field;
a base body, formed by molding a moldable material on the induction coil, and wrapping the induction coil; and
a sensing coating, formed on the base body, and configured to be penetrated by the variable magnetic field to generate heat.

13. A heater for an aerosol generation device, comprising:
an induction coil, configured to generate a variable magnetic field; and
a susceptor, configured to be penetrated by the variable magnetic field to generate heat, wherein the susceptor is formed by molding a moldable sensing material on the induction coil, and wraps the induction coil.

14. (canceled)

15. (canceled)

16. (canceled)

17. (canceled)

18. The aerosol generation device according to claim 2, wherein the induction coil is constructed in a form of a spiral coil extending in an axial direction of the heater; and a section of a conducting wire material of the induction coil is constructed to be in a flat shape.

19. The aerosol generation device according to claim 3, wherein the induction coil is constructed in a form of a spiral coil extending in an axial direction of the heater; and a section of a conducting wire material of the induction coil is constructed to be in a flat shape.

20. The aerosol generation device according to claim 18, wherein the section of the conducting wire material of the induction coil is constructed to have an extension size in an axial direction of the induction coil greater than an extension size in a radial direction.

21. The aerosol generation device according to claim 19, wherein the section of the conducting wire material of the induction coil is constructed to have an extension size in an axial direction of the induction coil greater than an extension size in a radial direction.

22. The aerosol generation device according to claim 2, wherein the heater further comprises:
a conductive pin, connected to the induction coil, to supply power to the induction coil,
wherein the conductive pin at least partially penetrates from the inside of the susceptor to the outside of the susceptor.

23. The aerosol generation device according to claim 3, wherein the heater further comprises:
a conductive pin, connected to the induction coil, to supply power to the induction coil,
wherein the conductive pin at least partially penetrates from the inside of the susceptor to the outside of the susceptor.

24. The aerosol generation device according to claim 22, wherein the conductive pin comprises a first conductive pin and a second conductive pin that are of different materials, to form, between the first conductive pin and the second conductive pin, a thermocouple configured to sense a temperature of the heater.
